(19) United States
(12) Patent Application Publication
(10) Pub. No.: US 2020/0273063 A1
(43) Pub. Date: Aug. 27, 2020

(54) DYNAMIC CAMPAIGN ANALYTICS VIA HASHTAG DETECTION

(71) Applicant: SPRINKLR, INC., New York, NY (US)

(72) Inventors: Justin Trevor GARRITY, New York, NY (US); Ryan Robert Parr, New York, NY (US); David James Stewart, New York, NY (US); Dan Blaisdell, New York, NY (US)

(73) Assignee: SPRINKLR, INC., New York, NY (US)

(21) Appl. No.: 16/834,924

(22) Filed: Mar. 30, 2020

Related U.S. Application Data
(62) Division of application No. 15/246,061, filed on Aug. 24, 2016, now abandoned.
(60) Provisional application No. 62/211,196, filed on Aug. 28, 2015.

(51) Int. Cl. G06Q 30/02; G06Q 50/00

(52) U.S. Cl. CPC G06Q 30/0242; G06Q 50/01

(57) ABSTRACT

An operator enters a name of a company, product, or any other entity into a user interface. A hashtag analytic system then automatically discovers social media campaigns associated with that entity based on hashtag or keyword usage in associated posted messages. The hashtag analytic system may automatically discover the social media accounts for the entity and then scan messages posted on the social media accounts for hashtags. The hashtag analytic system groups together posted messages that include campaign related hashtags and generates analytics for the groups of messages associated with the same campaigns.

The present application is a divisional application U.S. application Ser. No. 15/246,061, filed Aug. 24, 2016, which claims priority to U.S. Provisional Patent Application Ser. No. 62/211,196, filed Aug. 28, 2015, the entire disclosures of which are incorporated herein by reference.

### BACKGROUND

Analytic systems measure social media performance across different conversations and social accounts. The analytics are generally very broad and are only specific on a custom report basis. For example, custom software is typically developed to display specific custom reports associated with a particular business entity and/or social media campaign.

Data obtained from social network participation may identify marketing trends and effectiveness of media campaigns for particular products or branding projects. For example, the data may identify the number of participants registering or joining a particular social media network and gauge the interest level in an associated product. The social media participants may have profiles, including date of birth, gender, credit score, etc., that help identify what audiences or consumer demography are most interested in a product.

It may be difficult to identify and track all the social media associated with different social media campaigns. For example, a company may continually launch different product campaigns on different social media networks. Custom reporting software may not track every campaign launched on every social media network or track campaigns launched after development of the custom report software. Therefore, existing analytic systems may not provide a complete picture of brand performance over different social media networks.

### BRIEF DESCRIPTION OF THE DRAWINGS

FIG. 1 depicts an example hashtag analytic system.

FIG. 2 depicts example campaign hashtags identified by the hashtag analytic system.

FIG. 3 depicts the hashtag analytic system of FIG. 1 in more detail.

FIG. 4 depicts an example process for identifying social media campaigns.

FIG. 5 depicts example brand analytics generated by the hashtag analytic system.

FIG. 6 depicts example customer generated content analytics generated by the hashtag analytic system.

FIG. 7 depicts example demographic analytics generated by the hashtag analytic system.

FIG. 8 depicts an example computing device used in the hashtag analytic system.

### DETAILED DESCRIPTION

Companies, organizations, or individuals post messages on different social networks, sometimes multiple times a day. The posted messages often include hashtags. Repetitive use of the hashtags may actually indicate the beginning, end, and current campaigns and the importance of a campaign to a brand. A hashtag analytic system may use the hashtags to identify social media campaigns and generate analytics for the campaigns.

An operator only has to enter a name of a company, product, or any other entity into a user interface. The hashtag analytic system then automatically discovers social media campaigns associated with that entity based on hashtag or keyword usage in associated posted messages. The hashtag analytic system may automatically discover the social media accounts for the entity and then scan messages posted on the social media accounts for hashtags. The hashtag analytic groups together posted messages that include campaign related hashtags and generates analytics for the groups of messages associated with the same campaigns.

The hashtag analytics provide marketers valuable insight into types of audiences and subjects of interest to those audiences. The hashtag analytics can be extrapolated as representations of target audiences for other marketing campaigns or target consumers for products or services. For instance, by collecting the specific audience of participants that include specific hashtags in their posted messages, a marketer may determine specific subjects of interest to that audience. A marketer then may identify broader advertising campaigns for identified subjects that may do well if placed in related environments, media, or publications.

The hashtag analytic system may evaluate posted messages for a particular product or branding campaign from groups of otherwise unrelated participants to better understand the overall effectiveness of a marketing strategy. The hashtag analytic system also may cross-reference between one or more communities of participants to evaluate what products and/or services a select group of participants may more likely buy or use.

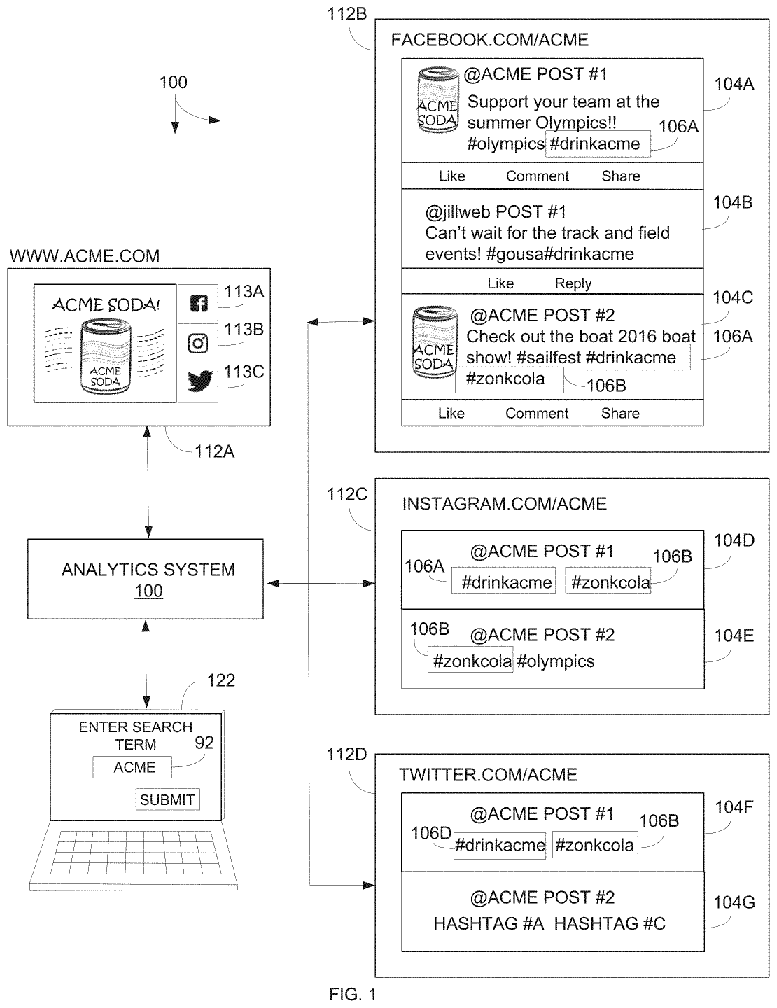

FIG. 1 shows a hashtag analytic system 100 (analytic system) that automatically identifies social media campaigns associated with a particular company or other entity and then automatically generates analytics associated with the identified campaigns.

A user may access analytic system 100 via a computer 122, such as a laptop, personal computer, notebook, or smart device. The user may enter a search term 92 into computer 122 associated with any entity, such as a company, brand, person, name, event, service, product, subject, issue, etc. For example, a user may enter the name of a company Acme into a field on a user interface operating on computer 122.

Analytics system 100 may assume that the search term Acme is the name of an entity associated with a universal resource locator (URL), such as Acme.com. Analytics system 100 may use the URL to identify different products and social media associated with Acme. For example, analytic system 100 may identify links 113A, 113B, and 113C on a www.acme.com webpage identifying different social media accounts. In this example, link 113A may identify an Acme Facebook® social media account, link 113A may identify an Acme Instagram® social media account, and link 113C may identify an Acme Twitter® social media account.

Alternatively, analytic system 100 may assume Acme operates certain social media accounts, such as www.facebook.com/acme; www.instagram.com/acme; and www.twitter.com/acme. Of course these are just examples and analytic system 100 may identify any account on any social media network associated with any entity.

Analytics system 100 also may automatically create a map of different products associated with Acme. For example, Acme may sell multiple different brands of soft drinks. The different brands may include separate webpages and/or have a webpage hierarchy on the Acme.com website 112A. Analytics system 100 may identify the different brands or products on the Acme website 112A and also identify the links to different social media accounts for each of the identified brands or products. Automatically identifying different products or bands associated with an entity is also described in co-pending U.S. patent application Ser. No. 15/160,694, Entitled: Social Media Enhancement, filed May 20, 2016, which is herein incorporated by reference in its entirety.

Analytics system 100 accesses social media accounts 112B-112D identified in Acme website 112A. For example, analytic system 100 may scan and/or download messages 104A-104C posted by the Acme Facebook® social media account 112B. Similarly, analytic system 100 may scan and/or download messages 104D and 104E posted on the Acme Instagram® account 112C, and messages 104F and 104G posted on the Acme Twitter® account 112D.

Analytics system 100 may assume most campaigns launched by a company have associated hashtags, keywords, or mentions. For example, the Acme company may post messages 104 that include certain hashtags 106 associated with different social media campaigns.

In this example, Acme may post a message 104A on social media account 112B that includes the hashtags # olympics and # drinkacme and may post a message 104C that includes the hashtags # drinkacme and # zonkcola. Acme may post message 104D on social media account 112C that includes the hashtags # drinkacme and # zonkcola and post message 104E on social media account 112D that includes the hashtags # drinkacme and # zonkcola.

Analytics system 100 may identify hashtags associated with campaigns based on the number of times the hashtags are used in posted messages. For example, analytic system 100 may associate any hashtag 106 with a campaign when used in two or more messages 104 posted by the same and/or different Acme social media accounts 112. In this example, two messages 104A and 104C posted by the @Acme Facebook® account include # drinkacme hashtag 106A. Accordingly, analytic system 100 associates hashtag 106A with a campaign.

Based on the identified campaign, analytic system 100 may generate metrics associated with the # drinkacme hashtag. For example, analytic system 100 may generate metrics for any messages 104A-104C on the Facebook® social media network that include the # drinkacme hashtag. For example, analytic system 100 may identify impressions, views, posts, influencers, likes or any other type of participant engagement with the # drinkacme campaign. Analytics system 100 also may identify demographics for the participants interacting with the # drinkacme campaign.

Analytic system 100 may discover other campaigns launched by the same entity. For example, analytic system 100 may identify a second hashtag 106B used multiple times in messages posted in social media account 112C. Accordingly, analytic system 100 may download all of the messages posted on social media account 112C that include # zonkcola hashtag 106B and generate associated metrics. Analytics system 100 also may compare analytics for different identified campaigns, such as comparing the number of impressions, user posts, demographics and any other user generated content (UGC) for the # drinkacme and # zonkcola campaigns.

If a campaign is identified in any one social media account 112, analytic system 100 may identify posted messages on other identified social media accounts 112 that include the associated hashtag and generate associated analytics. In another example, analytic system 100 may associate a hashtag with a campaign when the same hashtag is used in messages posted in two or more social media accounts 112. For example, social media accounts 112B, 112C, and 112D have all posted messages that include the # drinkacme and # zonkcola hashtags.

Thus, analytic system 100 automatically identifies any campaigns launched by an entity and automatically generates analytics associated with the identified campaigns based on a single search term 92 entered into computer 122. Analytic system 100 generates real-time less expensive social media analytics with more comprehensive views of all social media campaigns without having to create custom campaign reports.

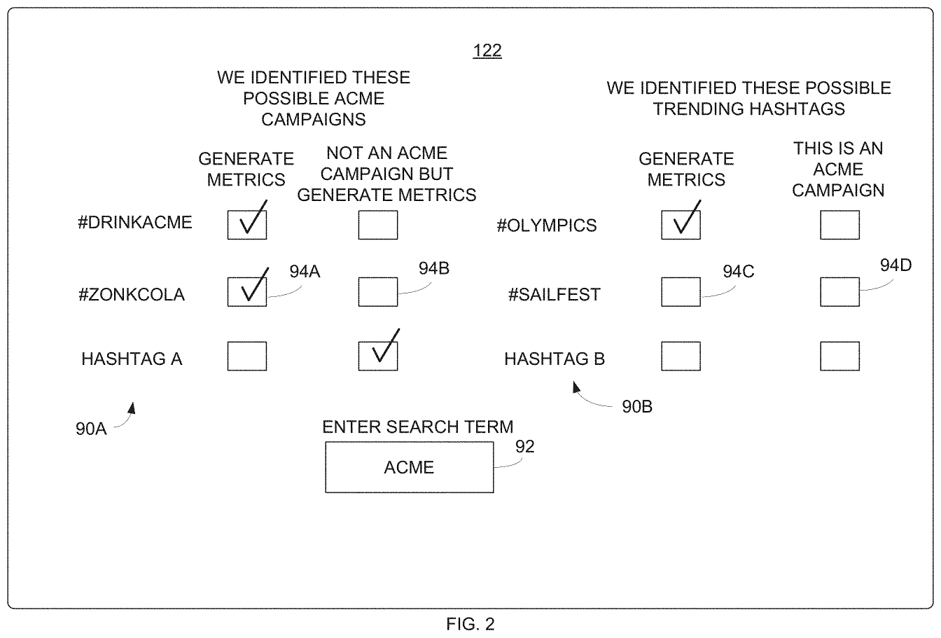

FIG. 2 shows initial search results from the analytic system. Referring to FIGS. 1 and 2, a user enters a search term 92, such as Acme, into a field displayed on computer 122. Analytic system 100 may access a webpage and/or social network accounts associated with the Acme search term as described above in FIG. 1.

Analytics system 100 scans the social media accounts as described above to identify different hashtags. Analytics system 100 may identify a first group of hashtags 90A as possibly associated with Acme campaigns. For example, analytic system 100 may list hashtags 90A used in multiple Acme posted messages as possible campaigns. Analytics system 100 may list other highest trending hashtags 90B that are not used multiple times in multiple Acme posts and/or are used in messages posted by Acme account participants.

Analytics system 100 may display a first column of check boxes 94A that a user may select to confirm which hashtags 90A are associated with actual Acme campaigns. Analytic system 100 may generate analytics for hashtags selected in boxes 94A. Analytics system 100 may display a second column of check boxes 94B that the user may select to identify hashtags 90A that are not Acme campaigns. In one example, analytic system 100 may generate analytics for the non-campaign hashtags selected in boxes 94B.

Analytic system 100 may display a third column of check boxes 94C for trending hashtags 90B that are not initially identified as associated with campaigns. For example, Acme accounts may post messages that include popular hashtags that are not necessarily associated with Acme products or services. These are typically indicated by a single post or a couple of posts in one day

A user has the option of directing analytic system 100 to generate metrics for trending hashtags 90B by selecting associated boxes 94C. For example, the user may be interested in viewing the demographic data for a trending hashtag 90B associated with the summer Olympics. Based on the demographics, the user may add the trending hashtag and/or other related content to messages for a particular campaign.

Analytics system 100 may display a fourth column of check boxes 94D that a user may select to identify hashtags that were initially identified as trending hashtags but are identified by the user as associated with Acme campaigns. Analytics system 100 may move hashtags 90B selected in boxes 94D to hashtags list 90A.

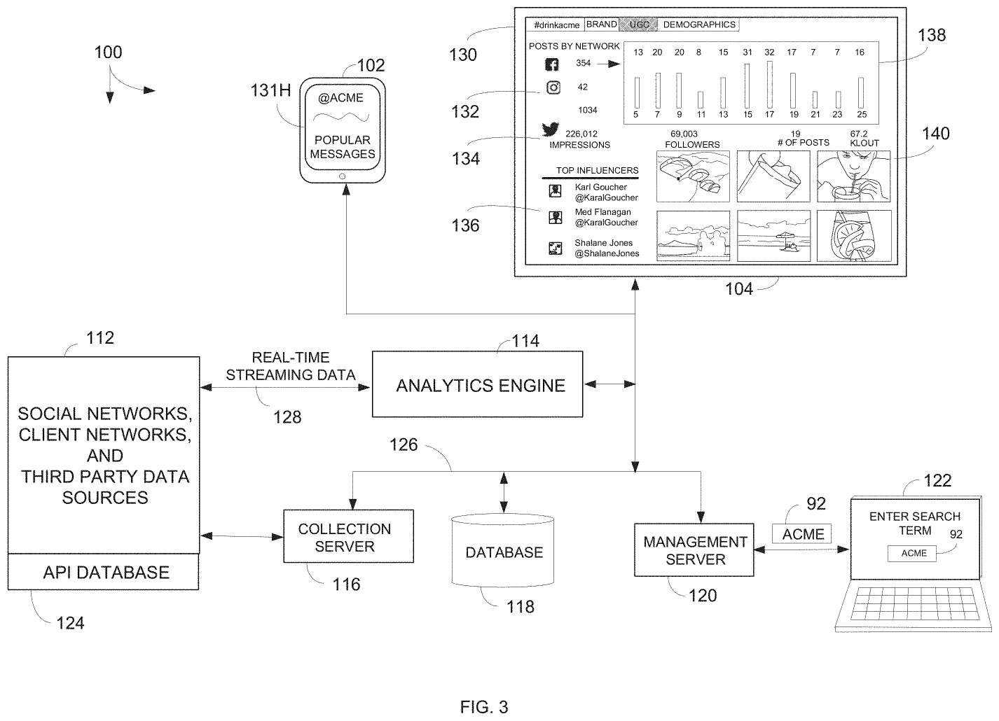

FIG. 3 shows hashtag analytic system 100 in more detail. An analytics engine 114 may connect to different display devices 102 and 104. For example, display device 102 may include a portable notebook, portable tablet, smart phone, smart watch, personal computer, or the like, or any combination thereof. Display device 104 include a display screen, such a light emitting diode (LED) screen, a liquid crystal display (LCD) screen, or any other type of screen or display device. Analytics engine 114 also connects to a computer 122 that may include a personal computer (PC), laptop, tablet, smart phone, smart watch, or any other computing device that can initiate a campaign search.

Analytic system 100 may access different data sources 112, such as social networks, client networks, or any other source of social media content or analytic data. As mentioned above, social networks may include social media websites, such as Twitter®, Facebook®, Instagram®, or the like. Client networks may include websites for a company, individual, or any other entity associated with social media. For example, client networks may include the www.acme.com website and other Acme company databases.

Third party data sources 112 may include websites such as Adobe® or Google® analytics that monitor, measure, and/or generate metrics for social media, data sources, websites, etc. Another example third party data source 112 may include customized databases, such as created by Salesforce®, Salesforce® Radian6, or Sysomos® that provide access to marketing and sales data.

Some data sources 112 may provide content, such as posted messages, and other data sources 110 may provide more numerical data such as, analytic data, company sales data, inventory data, financial data, spreadsheet data, website ecommerce data, wrist band radio frequency identification (RFID) reader data, number web page views, number of unique page views, time on web pages, starting web page, bounce rates, percentage of exists from web pages, impressions, Klout, or any other analytic data that may be relevant to a social media campaign.

Analytics engine 114 and collection server 116 may use database application programmer interfaces (APIs) 124 to access data from data sources 112. For example, analytics engine 114 may use APIs 124 to extract real-time streaming data 128 from data sources 112. Collection server 116 also may use APIs 124 to extract and store data 126 from data sources 112 in a database 118. Streaming data 128 may be similar to data 126 and may include real-time updates to data already stored in database 118.

A user may enter search term 92 into computer 122. For example, the user may enter any keyword, data string, term, value, or any other combination of characters into computer 122. In one example, search term 92 may include the name of company or person, a name of a product or service, a brand name, a name of a campaign or event associated with a company or person, a name of a department within a company, a name of an account on a social website, a name of a subject or account, a hashtag name associated with the person or company, a name of a competitor or competitive product, or the name of any other service, item, topic, data category, content, event, or any other entity identifier.

A management server 120 may direct collection server 116 and/or analytics engine 114 to identify and extract data from data sources 112 associated with search term 92. For example, management server 120 may direct collection server 116 or analytics engine 114 to search for different social media accounts on the www.acme.com website and extract or scan data for different products or services sold on the www.acme.com website.

Collection server 116 may download links to the social media accounts and product information into database 118. Management server 120 then may direct collection server 116 to download content from the social media accounts identified on the Acme website. For example, collection server 116 may download or scan posted messages from the www.facebook.com/acme social media account into database 118. Alternatively, a user may enter the social media account directly into computer 122 as search term 92.

Management server 120 and/or analytics engine 114 then may identify campaigns launched by Acme based on the hashtags in the posted messages. As mentioned above, analytic system 100 may count the number of times the same hashtag or keyword is used in different posted messages. Analytic system 100 may identify any hashtag or keyword used more than some threshold number of times in Acme posted messages as associated with a campaign.

Analytic system 100 then may cause collection server 116 to download messages posted by the Acme account or posted by Acme account participants that include the identified campaign hashtag. Analytic system 100 may download any other analytics associated with the downloaded messages, such as participant influencer data. Analytic system 100 then may cause analytics engine 114 to start downloading real-time streaming data 128 from data sources 112 that include, or are associated with, the identified campaign hashtag.

Analytics engine 114 may group together content based on the identified campaign hashtag. For example, an identified campaign may include all of the messages posted by the Acme account that include the identified campaign hashtag and include all of the messages posted by participants underneath the Acme posted messages, such as posted messages, replies, comments, etc. The campaign data may include any other data associated with the campaign hashtag.

Analytics engine 114 may generate and display content and analytics related to the campaign hashtag on display devices 102 and/or 104. For example, analytic system 100 may display a menu 130 that identifies a selected campaign hashtag, such as # drinkacme. The user may select brand analytics, user generated content (UGC) analytics, or demographics from menu 130. Some analytics are described in more detail below and are just examples of any analytic data that may be downloaded and/or generated by hashtag analytic system 100.

In response to the user selecting UGC analytics from menu 130, analytics engine 114 may identify a number of messages 132 posted by different participants on different Acme social media accounts that are part of the # drinkacme hashtag thread. Analytics server 114 also may display analytics 134 that identify the number of impressions, number of followers, number of acme posts and Klout for the # drinkacme campaign.

Analytics system 100 may identify the top influencers 136 that posted messages including the # drinkacme hashtag. Top influencers 136 may include participants with the largest number of followers, such as celebrities, journalists, experts, etc. Analytic system 100 also may display histograms 138 identifying the number of messages posted by participants on the different social media account over different days of the past month.

Analytics system 100 also may display highest trending user posts 140, posts with the largest number of likes, or participants with the largest number of followers. Again, these are just examples of any combination of content and analytic data may be downloaded, generated, and displayed by analytic system 100.

A user may enter a new search term 92 into computer 122. Management server 120 may identify previously grouped social media associated with the new search term 192. If content does not currently exist, management server 120 may direct collection server 116 and analytics engine 114 to search data sources 112 for associated websites and social media accounts associated with the new search term 92 as described above. Analytic system 100 then identifies the campaigns and generates the associated metrics as also described above.

Thus, analytic system 100 provides the unique features of identifying different campaigns for an entity and then automatically generating metrics for the identified campaigns based on a single search term.

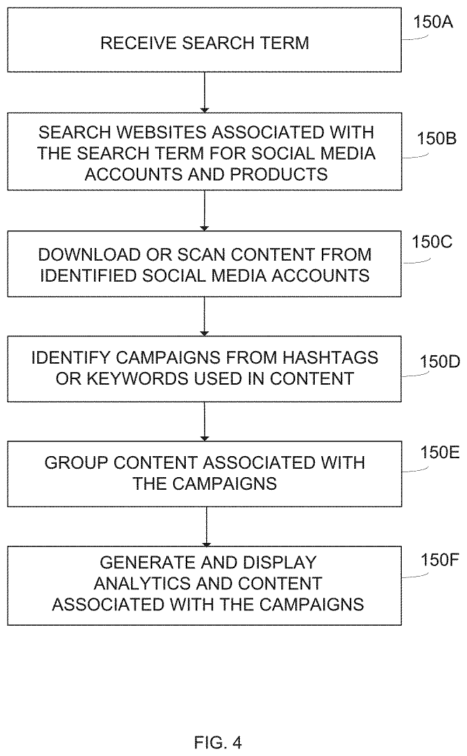

FIG. 4 shows an example campaign identification process. In operation 150A, the analytic system receives a search term. As mentioned above, the search term may include any identifier of any type of entity, including a company name, product or service name, campaign name, hashtag, keyword, event, or the like, or any combination thereof.

In operation 150B, the analytic system searches websites, or any other data sources associated with the search term, for social media accounts. For example, the analytic system may search for any links or content on a brand website identifying social media accounts.

In operation 150C, the analytic system may download content from the identified social media accounts. For example, the analytic system may download messages posted both by the identified social media account and by participants interacting on the social media accounts. Alternatively, the analytic system may just scan the posted messages for specific data without first downloading the posted content into the analytic system database.

In operation 150D, the analytic system may identify hashtags or other keywords, used in the downloaded social media. The analytic system then identifies hashtags or keywords associated with campaigns. For example, analytic system may count the number of times a particular hashtag or keyword is included in messages posted by the social media account.

The analytic system may use different criteria for determining if the hashtag is associated with a campaign. For example, the analytic system may determine that any hashtag used two or more times on the same social media account as potentially associated with a campaign. Other criteria may identify campaigns based on the number of times the hashtag is used in messages posted on different social media accounts.

In operation 150E, the analytic system groups social media content together based on the identified campaigns. For example, the analytic system may group together a thread of all posted messages and associated analytic data associated with the identified campaign hashtag.

In operation 150F, the analytic system may generate and display analytics and content associated with the campaigns. As explained before, the analytic system may generate analytics for all of the messages posted by a social media account that include the campaign hashtag. The analytic system also may generate metrics for the participants posting messages or otherwise responding to the social media account posted content, such as impressions, number of participants, participant posts, etc. The analytic system also may generate demographic data for the participants, such as age, sex, race, interests, geographic locations, etc. The analytic system may use known filters to remove spam posts that could alter the campaign analytics.

The analytic system may continually monitor any identified social media accounts for new campaigns and update previously generated campaign analytics. For example, the Acme company may start a new campaign on a new soft drink. The analytic system may automatically identify the hashtag used in the new soft drink campaign, generate metrics for the new campaign, and display the newly identified campaign and associated analytics.

As mentioned above, the analytic system may generate analytics based on any group of social media associated with the identified campaign hashtag. In one example, the analytic system may generate analytics based only on posts that include the hashtag or may generate analytics that include other content associated with the social media accounts. Analytics generated for a specific set of posted messages that include the campaign hashtag may be more tailored to specific campaign topics and audiences.

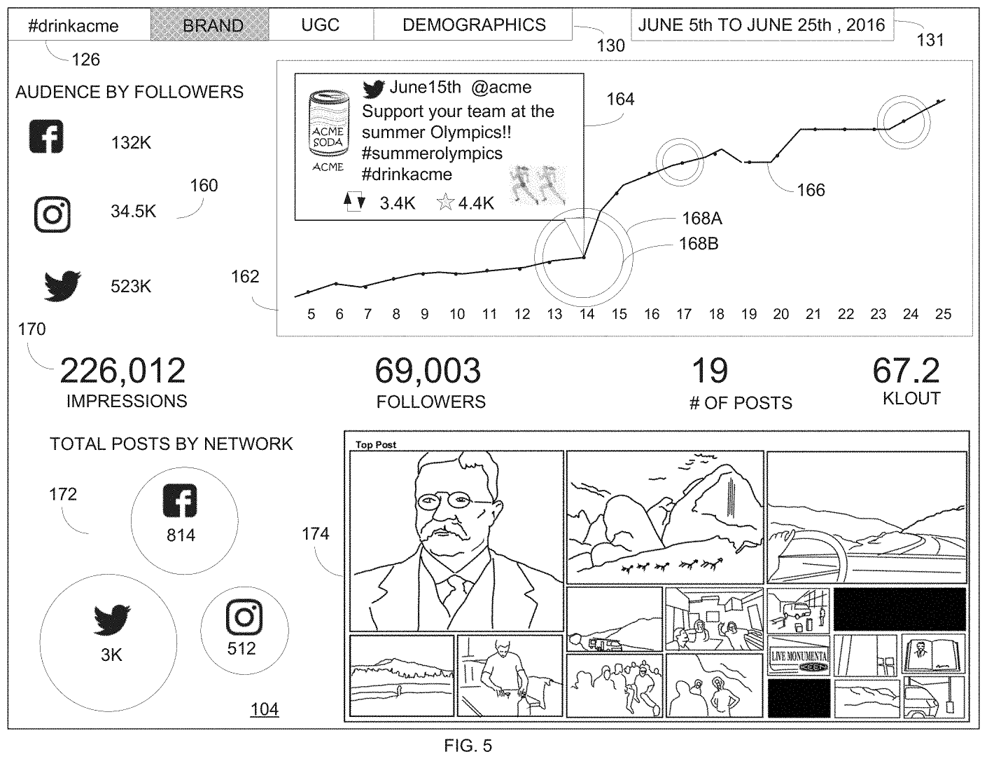

FIG. 5 shows example brand related analytics generated by the analytic system. The analytic system may display menu 130 in a top corner of display device 104. Menu 130 may display a selected campaign hashtag 126 in a first field. The user may select between brand analytics, UGC analytics, and demographic analytics within menu 130. The user also may select a time period 131 for the selected analytics such as, from June 5th to June 25th.

In response to the user selecting brand analytics from menu 130, the analytic system may identify the number of followers 160 on each Acme social media account. Followers are participants that subscribe to a social media account and/or choose to view posted messages from a particular social media account.

The analytic system may display a chart 162 that graphs specific social media activity at specific points in time overlaid on top of a trending line chart 166. For example, item 164 may be a post from an Acme Instagram® account that discusses the Summer Olympics. Line chart 162 may identify the total number of participants that have joined, registered, viewed, or otherwise interacted with posted messages and/or participated in a social network forum as a function of time.

The analytic system may display posted message 164 in combination with a set of layered circles 168 that each represent a different score based on volume for item 164. For example, an outer circle 168A may represent the number of likes for posted message 164 and an inner circle 168B may represent the number of comments for posted message 164 accumulated over the selected time period.

The effect of a particular hashtag post 164 attracting or eliciting participation in the broader social network forum may be determined from chart 162. For example, there may be a correlation between the numbers of likes and/or comments associated with a particular hashtag posted message 164 (as indicated by the size of one or both layered circles 168) and the effect of message 164 on the total number of participants identified by line chart 166.

In some cases a particular posted message 164 having relatively few comments and/or likes may nevertheless drive a disproportionately large increase in total participation in line chart 166, or vice versa. For example, messages 164 posted by participants having large user followings, such as celebrities, may be more influential in attracting additional participants compared with messages 164 posted by participants having fewer followers.

The analytic system also may display analytics 170 identifying the number of impressions and number of followers for the social media account and posted message associated with campaign hashtag 126. Impressions in the context of online advertising indicate the number of times an advertisement is fetched from its source.

The analytic system also may generate a Klout score typically a number between 1 and 100 that represents an influence of the social media campaign. The more influential the campaign, the higher the Klout score. Impressions, followers, and Klout scores are known to those skilled in the art and therefore are not described in further detail.

The analytic system may identify the total number of messages 172 posted on each social media account that include hashtag 126. The analytic system also may identify the most popular messages 174 posted by the social media accounts that include hashtag 126. For example, posted messages 174 and associated sub-tree messages may have the largest number of likes.

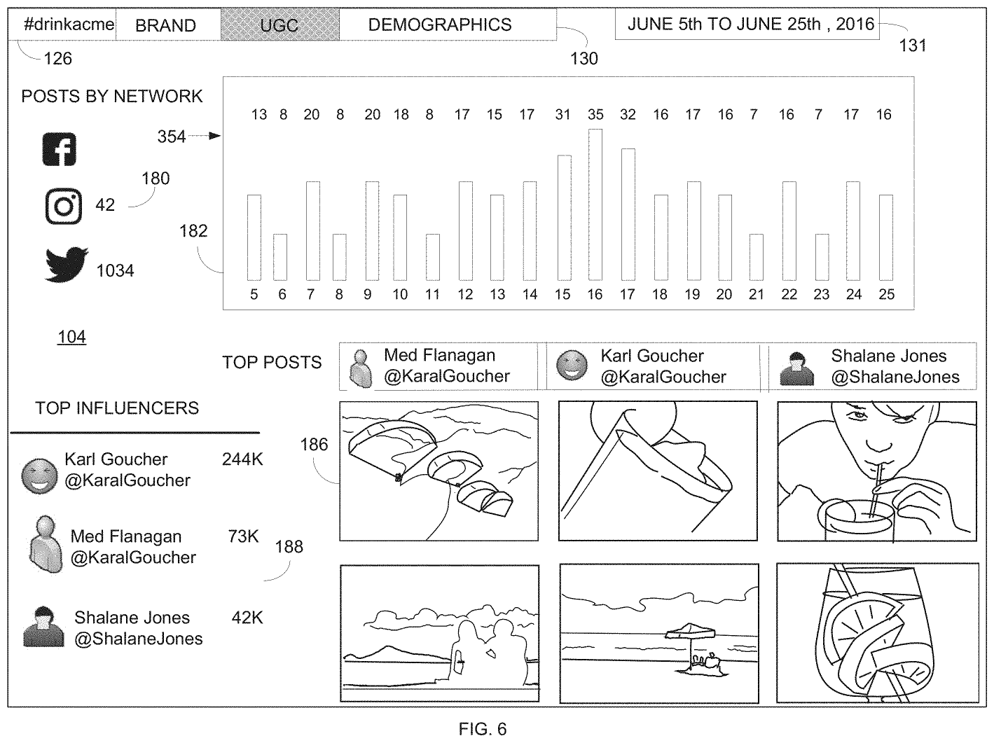

FIG. 6 shows one example of user generated content (UGC) analytics associated with hashtag 126. In response to selection of the UGC icon in display menu 130, the analytic system may identify the number of messages posted by participants on different social media accounts 180 that include hashtag 126.

The analytic system may display a histogram chart 182 that identifies the number of user posted messages for a selected one of social media accounts 180 over a selected time period. The analytic system also may identify the top influencers 188 that posted messages including hashtag 126. For example, top influencers 188 may be celebrities with large numbers of followers. The analytic system also may display the top messages 186 posted by participants, such as with the largest number of likes.

The UGC analytics represent earned social media marketing created by participants other than the entity that operates the social media account. For example, photos in messages 186 may provide insight into what content customers use in responses. The brand may then use similar photos to increase participant engagement or sponsor related types of events.

The analytic system also may display analytics with brand colors. For example, the analytic system may extract a brand color scheme from a brand avatar and use the color scheme as a background for displaying brand analytics. Using brand themes is also described in described in co-pending U.S. patent application Ser. No. 15/160,694, Entitled: Social Media Enhancement, filed May 20, 2016, which has been incorporated by reference.

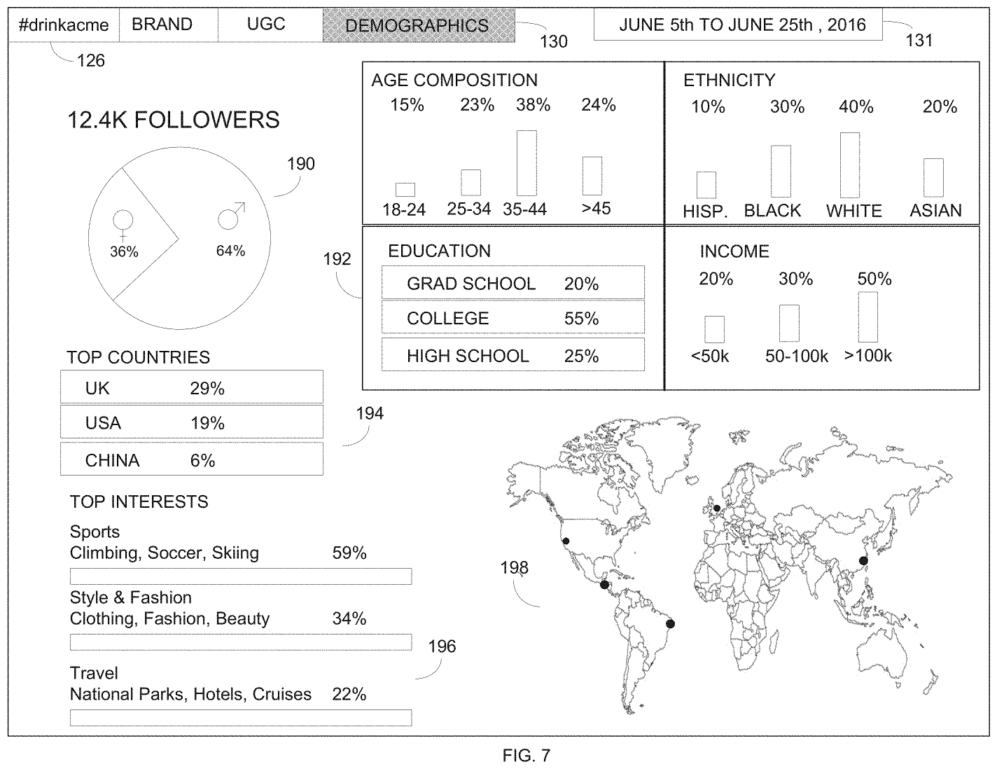

FIG. 7 shows example user hashtag related demographics generated by the analytic system. In response to selecting the demographics icon in display menu 130, the analytic system may generate different demographic data associated with hashtag 126. For example, pie chart 190 may indicate the percentage of male and female followers for the Acme social media accounts or related to hashtag 126.

The analytic system also may generate charts 192 that identify the percentages of Acme account followers by age, ethnicity, education, and income. Charts 194 may identify the percentage of Acme followers in different countries. The analytic system also may display charts 196 that identify top interests of the social media account followers. For example, top interests for 59% of the Acme followers may be climbing, soccer, and skiing.

Of course top interests may be identified for any subject, such as national news, national parks, politics, international news, bird watching, geology, etc. The analytic system also may identify top brands and/or top TV shows with the most number of followers, participants, fans, etc. The analytic system also may display a world map 198 that identifies the geographic locations of the Acme followers for hashtag 126.

The analytic system generates analytics for any participants and any participant interaction associated with the social media campaign. For example, participants may include anyone posting messages, or liking, sharing, viewing, commenting, mentioning, replying, or retweeting posted messages that include the campaign hashtag.

The analytic system may not have direct access to user profiles for some participants. The user profiles for theses participants may be separately obtained from a social network or other service provider and then linked to the message posted by the participant that includes the specific hashtag. The analytic system also may use other services to analyze different participant segments or may send captured data to third party services for analysis and providing specific insight on the different participants.

The analytic system may organize participants into verified and unverified groups. Verified groups are confirmed as associated celebrity or influential user accounts.

### Hardware and Software

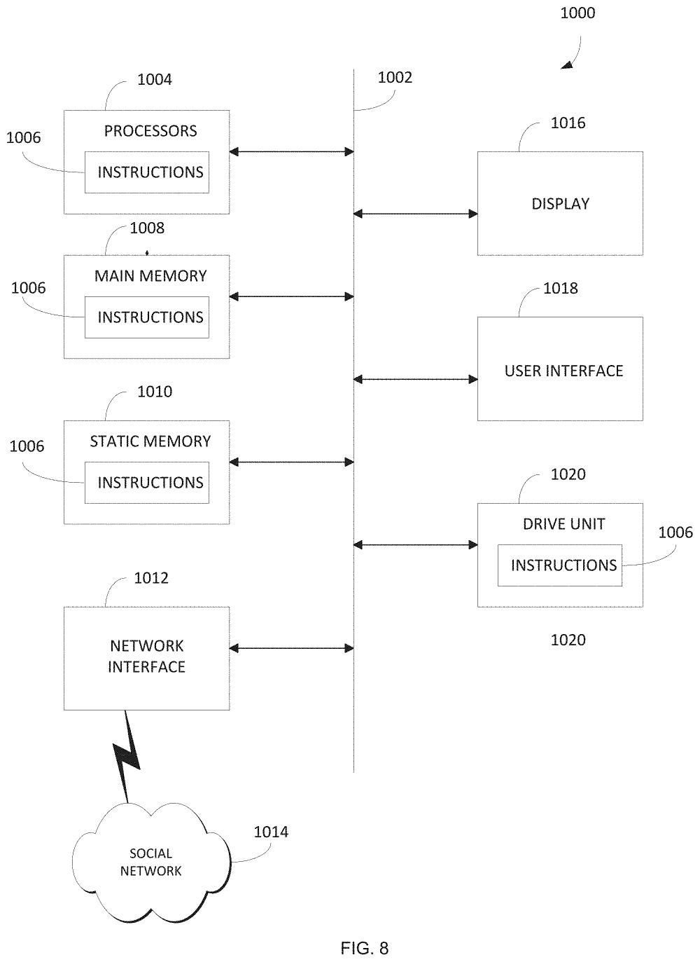

FIG. 8 shows a computing device 1000 that may be used for operating the analytic system computing devices and performing any combination of processes discussed above. The computing device 1000 may operate in the capacity of a server or a client machine in a server-client network environment, or as a peer machine in a peer-to-peer (or distributed) network environment. In other examples, computing device 1000 may be a personal computer (PC), a tablet, a Personal Digital Assistant (PDA), a cellular telephone, a smart phone, a web appliance, or any other machine or device capable of executing instructions 1006 (sequential or otherwise) that specify actions to be taken by that machine.

While only a single computing device 1000 is shown, the computing device 1000 may include any collection of devices or circuitry that individually or jointly execute a set (or multiple sets) of instructions to perform any one or more of the operations discussed above. Computing device 1000 may be part of an integrated control system or system manager, or may be provided as a portable electronic device configured to interface with a networked system either locally or remotely via wireless transmission.

Processors 1004 may comprise a central processing unit (CPU), a graphics processing unit (GPU), programmable logic devices, dedicated processor systems, micro controllers, or microprocessors that may perform some or all of the operations described above. Processors 1004 may also include, but may not be limited to, an analog processor, a digital processor, a microprocessor, multi-core processor, processor array, network processor, etc.

Some of the operations described above may be implemented in software and other operations may be implemented in hardware. One or more of the operations, processes, or methods described herein may be performed by an apparatus, device, or system similar to those as described herein and with reference to the illustrated figures.

Processors 1004 may execute instructions or “code” 1006 stored in any one of memories 1008, 1010, or 1020. The memories may store data as well. Instructions 1006 and data can also be transmitted or received over a network 1014 via a network interface device 1012 utilizing any one of a number of well-known transfer protocols.

Memories 1008, 1010, and 1020 may be integrated together with processing device 1000, for example RAM or FLASH memory disposed within an integrated circuit microprocessor or the like. In other examples, the memory may comprise an independent device, such as an external disk drive, storage array, or any other storage devices used in database systems. The memory and processing devices may be operatively coupled together, or in communication with each other, for example by an I/O port, network connection, etc. such that the processing device may read a file stored on the memory.

Some memory may be “read only” by design (ROM) by virtue of permission settings, or not. Other examples of memory may include, but may be not limited to, WORM, EPROM, EEPROM, FLASH, etc. which may be implemented in solid state semiconductor devices. Other memories may comprise moving parts, such a conventional rotating disk drive. All such memories may be “machine-readable” in that they may be readable by a processing device.

“Computer-readable storage medium” (or alternatively, “machine-readable storage medium”) may include all of the foregoing types of memory, as well as new technologies that may arise in the future, as long as they may be capable of storing digital information in the nature of a computer program or other data, at least temporarily, in such a manner that the stored information may be “read” by an appropriate processing device. The term “computer-readable” may not be limited to the historical usage of “computer” to imply a complete mainframe, mini-computer, desktop, wireless device, or even a laptop computer. Rather, “computer-readable” may comprise storage medium that may be readable by a processor, processing device, or any computing system. Such media may be any available media that may be locally and/or remotely accessible by a computer or processor, and may include volatile and non-volatile media, and removable and non-removable media.

Computing device 1000 can further include a video display 1016, such as a liquid crystal display (LCD) or a cathode ray tube (CRT) and a user interface 1018, such as a keyboard, mouse, touch screen, etc. All of the components of computing device 1000 may be connected together via a bus 1002 and/or network.

For the sake of convenience, operations may be described as various interconnected or coupled functional blocks or diagrams. However, there may be cases where these functional blocks or diagrams may be equivalently aggregated into a single logic device, program or operation with unclear boundaries.

Having described and illustrated the principles of a preferred embodiment, it should be apparent that the embodiments may be modified in arrangement and detail without departing from such principles. Claim is made to all modifications and variation coming within the spirit and scope of the following claims.

1. A computer program for identifying campaigns launched on social media networks, the computer program having access to social signal data published on the social media networks, wherein the social signal data comprises first information that includes a content of social media messages and second information that is different than the first information, wherein the second information includes metadata of the social media messages, the computer program comprising a set of instructions operable to:
identify a first attribute of the second information based on a search term received via a user interface, wherein the first attribute corresponds to an entity associated with one or more social media accounts originating some of the social media messages;
filter the social signal data based on the first attribute to obtain a first grouping of the social media messages;
scan the first grouping of the social media messages for hashtags;
identify a second attribute of the second information based on a number of times the hashtags are used in social media messages of the first grouping, wherein the second attribute is different than the first attribute, wherein the second attribute comprises frequently used hashtags;
identify clusters from the social signal data following identification of the frequently used hashtags, wherein the clusters include social media messages that include the frequently used hashtags and additional social media messages that are linked, by one or more third attributes of the second information, to the social signal messages that include the frequently used hashtags;
generate campaign analytics for all the social media messages of the clusters; and
display the campaign analytics on a display device.
